(19) United States
(12) Patent Application Publication
(10) Pub. No.: US 2009/0227148 A1
(43) Pub. Date: Sep. 10, 2009

(54) Electrical Connector

(75) Inventor: Norio Yoshida, Atsugi (JP)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 12/085,112

(22) PCT Filed: Nov. 17, 2006
(86) PCT No.: PCT/US2006/044554

§ 371 Date: Apr. 13, 2009

(30) Foreign Application Priority Data
Nov. 17, 2005 (JP) 2005-332397

(51) Int. Cl. H01R 9/03

(52) U.S. Cl. 439/658

(57) ABSTRACT

A connector (10) includes an insulative housing (11) having a plurality of terminal-receiving cavities (17). A plurality of conductive terminals (20) are mounted in the terminal-receiving cavities with each terminals having a contacting portion (21), a terminating portion (24), and a retention portion (22). The retention portion has at least one barb member (26) projecting therefrom and at least one reentrant portion (27) extending thereinto. The reentrant portion is positioned adjacent the barb member and in front of the barb member along the terminal insertion direction such that material displaced by the barb member is received in the reentrant portion during insertion of the terminal into the terminal-receiving cavity.

### BACKGROUND OF THE INVENTION

1. Field of the Invention

The present invention relates to a printed circuit board connector.

2. Description of the Related Art

Conventionally, a connector has been mounted on a substrate, such as a print circuit board, for use in connecting the substrate to other electric circuits and the like (for example, refer to Japanese Utility Model Publication (kokoku) No. H6-32769). This kind of connector has a plurality of terminals projecting from the connector housing.

FIG. 7 is a sectional view showing a part of a conventional connector.

As shown in FIG. 7, a reference numeral 301 designates a box-shaped housing for a connector mounted on a circuit substrate (not shown), made of insulating material. Further, a reference numeral 305 designates a terminal made of electrically conductive material, and mounted on the housing 301 and bottom plate 302. Then, a mating connector (not shown) is fit into the connector from above in the figure so as to electrically connect to the connector.

The terminal 305 includes a body portion 306; a connection portion 307 electrically connecting to a terminal of the mating connector by contacting therewith; an insertion portion 308, which is the root part of the connection portion 307 and fits into a terminal through-hole 303 formed on the bottom plate 302 of the housing 301; a solder tail portion 312 soldered to a contact pad of a circuit substrate (not shown); and a fixing projection 310 for fixing the terminal 305 to the housing 301. Further, the bottom plate 302 of the housing 301 has the terminal through-hole 303, into which the insertion portion 308 of the terminal 305 fits, and a fixing concave portion 304, into which the fixing projection 310 is inserted. Then, the terminal 305 is mounted in the housing 301 by inserting the insertion portion 308 into the terminal through-hole 303 and inserting the fixing projection 310 into the fixing concave portion 304 from the lower side of the bottom plate 302. In this instance, an barb 309 formed along the sides of the insertion portion 308 engages with the inner circumference wall of the terminal through-hole 303, and an engagement convex portion 311 formed along the sides of the fixing projection 310 engages with the inner circumference wall of the fixing concave portion 304. Therefore, the terminal 305 is firmly mounted in the housing 301, and does not detach from the housing 301.

However, in the conventional connector, when the insertion portion 308 of the terminal 305 is inserted into the terminal through-hole 303 of the housing 301, the barb 309 of the insertion portion 308 inserted into the terminal through-hole 303 from below the bottom plate 302 pushes aside a portion of the inner circumference wall of the terminal through-hole 303, and therefore, a rise 313 is formed on the upper surface of the bottom plate 302 around the terminal through-hole 303, in some cases. Especially, when the connecter is downsized, the bottom plate 302 becomes thin in thickness (for example, less than 1 mm), and the barb 309 almost reaches to the upper surface of the bottom plate 302, therefore the rise 313 is easily formed.

### SUMMARY OF THE INVENTION

An object of the present invention is to solve the above-mentioned problem in the conventional connectors and to provide a connector free from terminal detachment from the housing. This is accomplished by forming an anchor concave portion in a position adjoining the upper side of an barb formed along the sides of the insertion portion of the terminal, and which a periphery of the terminal through-hole situated on the upper side of bottom plate of the housing is maintained flat. The retention force between the insertion portion of the terminal and the terminal through-hole increases due to an anchor effect of the barb and the anchor concave portion.

In order to achieve the above object, the present invention provides a connector comprising a connector body fitting into a mating connector and a terminal held in the connector body and electrically connected to a terminal of the mating connector. The connector body includes a terminal holder plate in which a terminal through-hole is formed; the terminal includes an insertion portion, which is inserted into the terminal through-hole, and a connection portion connecting to the front end of the insertion portion along an insertion direction and contacting a terminal of the mating connector. The insertion portion includes an barb projecting outwards from the sides of the terminal and digging into a sidewall of the terminal through-hole. The insertion portion also includes an inward reentrant anchor concave portion formed in a position adjoining a front side of insertion direction of the barb. The anchor concave portion is not exposed from a front surface of the terminal holder plate along the insertion direction when the terminal is fully seated in the terminal holder plate.

Another object of the present invention is to provide a sidewall of the terminal through-hole including a hollow portion, which is formed on a back side of the insertion direction of the barb by being pushed aside by the barb, and a bulge, which is formed on the front side of the insertion direction of the barb and enters the anchor concave portion. Preferably, a volume of the bulge is equivalent to a volume of the portion pushed aside by the barb.

Another object of the present invention is to provide a terminal holder plate including an auxiliary concave portion formed on a surface on the back side of the insertion direction, the terminal includes a body portion connected at a back end of the insertion direction of the insertion portion and an auxiliary projection extending from the body portion along the insertion direction, and the auxiliary projection is caught by being inserted into the auxiliary concave portion.

Still, another object of to the present invention is to provide, in the connector, an anchor concave portion formed in a position adjoining an upper side of an barb formed along the sides of an insertion portion of a terminal. Therefore, a periphery of the terminal through-hole situated on an upper side of bottom plate of a housing may be maintained flat, and also insertion force between the insertion portion of the terminal and the terminal through-hole increases due to an anchor effect of the barb and the anchor concave portion, by which the terminal will not detach from the housing.

A connector includes an insulative housing with a plurality of terminal-receiving cavities for receiving terminals inserted therein in a terminal insertion direction. A plurality of conductive terminals are provided with each terminal being mounted in one of the terminal-receiving cavities. Each of the conductive terminals includes a contacting portion, a terminating portion and a retention portion. The retention portion includes at least one barb member projecting therefrom and at least one reentrant portion extending thereinto. The reentrant portion is positioned adjacent the barb member and in front of the barb member along the terminal insertion direction such that material displaced by the barb member is received in the reentrant portion upon insertion of the terminal into its terminal-receiving cavity.

The conductive terminals may include an auxiliary retention portion laterally offset from the retention portion relative to the terminal insertion direction. The housing may include a plurality of side walls and a bottom wall cooperatively defining an opening for receiving a mating connector. The terminal-receiving cavities may be formed in the bottom wall of the housing. The reentrant portion of each terminal may be positioned within one of the terminal-receiving cavities.

A connector includes an insulative housing with a plurality of terminal-receiving cavities and a plurality of conductive terminals inserted into the terminal-receiving cavities in a terminal insertion direction. Each of the conductive terminals includes a contacting portion, a terminating portion and a retention portion. The retention portion includes at least one barb member projecting from the retention portion and at least one reentrant portion extending into the retention portion. The reentrant portion is positioned adjacent to and in front of the barb member in the insertion direction. The retention portion further includes an auxiliary retention portion laterally offset from the retention portion and includes a projection that is inserted into a recess formed in the insulative housing. Material displaced by the barb member during insertion of the terminal into the terminal-receiving cavity is received in the reentrant portion.

The housing may include a plurality of side walls and a bottom wall cooperatively defining an opening for receiving a mating connector. The terminal-receiving cavities may be formed in the bottom wall of the housing. The reentrant portion of each conductive terminal may be embedded in one of the terminal-receiving cavities.

A connector includes an insulative housing having side surfaces and a bottom surface interconnecting the side surfaces with the side surfaces and bottom surface defining an opening for receiving a mating connector. The bottom surface has a plurality of terminal-receiving passageways extending therethrough. A plurality of conductive terminals are inserted into the terminal-receiving passageways in a terminal insertion direction. Each of the conductive terminals includes a contacting portion, a terminating portion and a retention portion. The retention portion includes at least one barb member projecting therefrom and at least one reentrant portion extending thereinto. The reentrant portion is located adjacent the barb member and in front of the barb member relative to the insertion direction such that material displaced by the barb member during insertion into the terminal-receiving cavity is received in the reentrant portion.

Each of the conductive terminals may include an auxiliary retention portion laterally offset from the retention portion and along the insertion direction. Each reentrant portion of the retention portion may be completely within one of the terminal receiving cavities within the bottom wall of the housing.

Other objects, features and advantages of the present invention will be apparent from the following detailed description taken in conjunction with the accompanying drawings.

### BRIEF DESCRIPTION OF THE DRAWINGS

FIG. 1 is a side view showing a connector according to an embodiment of the present invention.

FIG. 2 is a plan view showing the connector according to the embodiment of the present invention.

FIG. 3 is a sectional view showing the connector according to the embodiment of the present invention and is a sectional view AA of FIG. 2.

FIG. 4 is a front view showing a connector terminal according to the embodiment of the present invention.

FIG. 5 is a side view showing the connector terminal according to the embodiment of the present invention.

FIG. 6 is a diagram showing an engagement state of an insertion portion of the terminal and the sidewall of a terminal through-hole according to the embodiment of the present invention and is an enlarged view of B part shown in FIG. 3.

FIG. 7 is a sectional view showing a part of a prior art connector.

### DESCRIPTION OF THE PREFERRED EMBODIMENTS

An embodiment of the present invention is described below in detail with reference to the accompanying drawings.

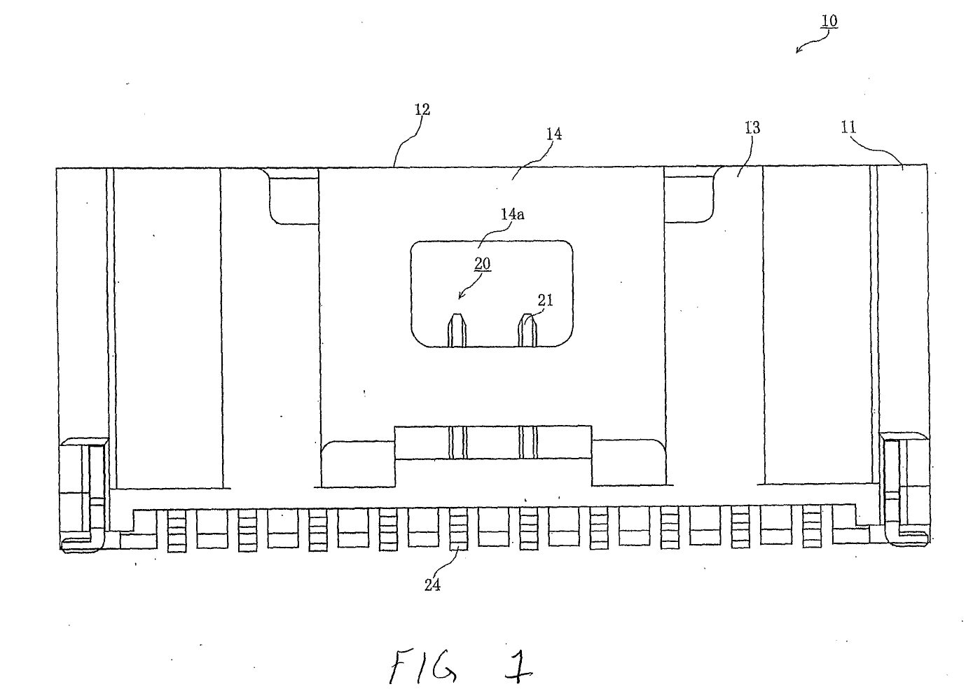

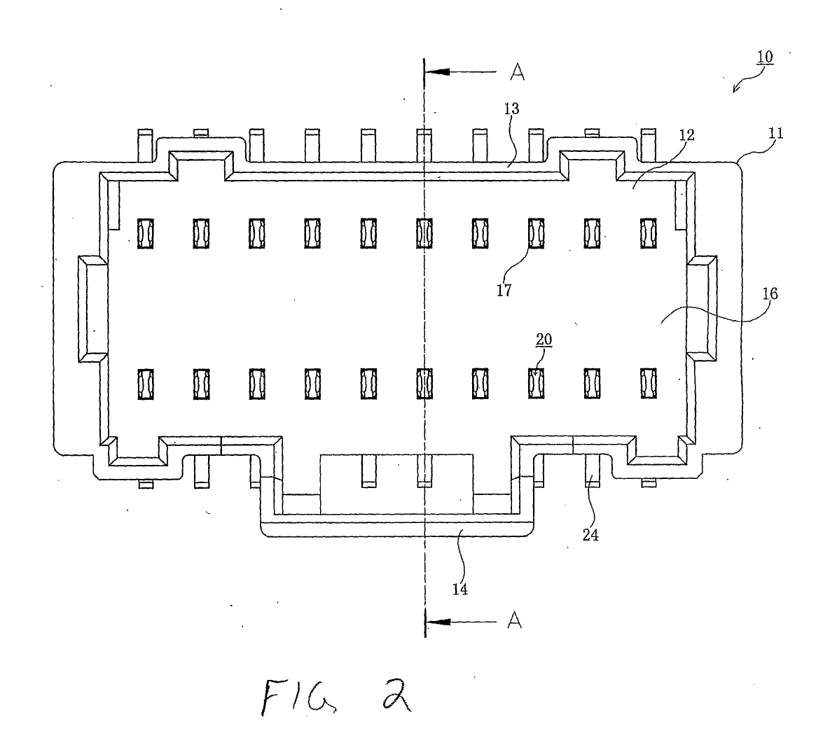

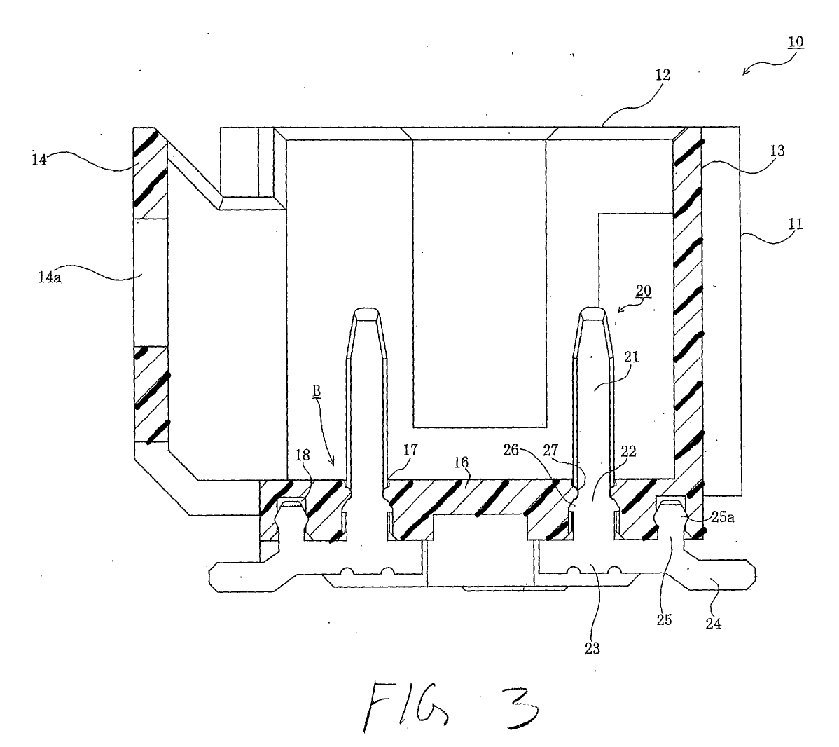

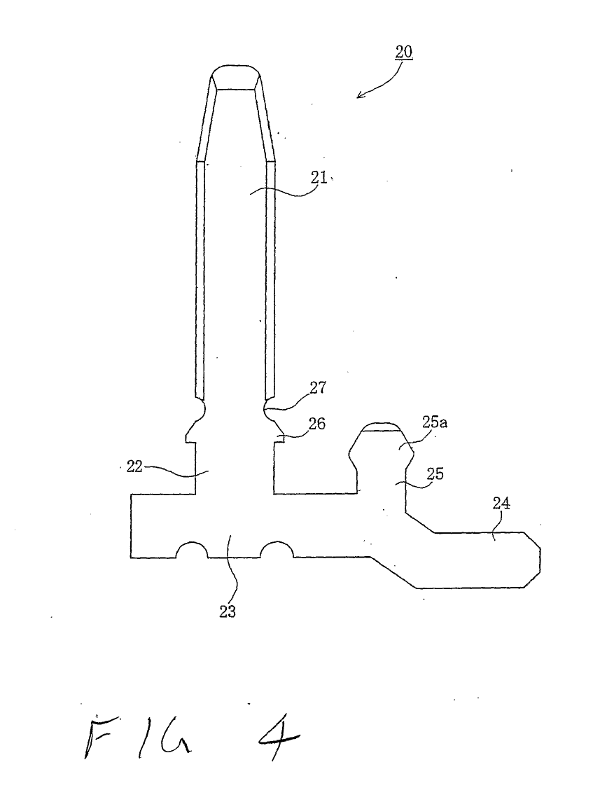

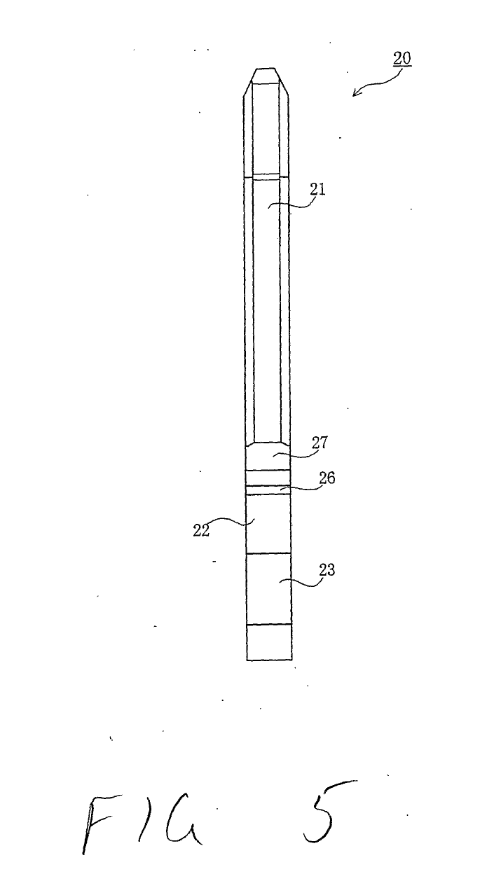

FIG. 1 is a side view showing a connector according to the embodiment of the present invention, FIG. 2 is a plan view showing the connector according to the embodiment of the present invention, FIG. 3 is a sectional view showing the connector according to the embodiment of the present invention and is a sectional view AA of FIG. 2, FIG. 4 is a front view showing a connector terminal according to the embodiment of the present invention, and FIG. 5 is a side view showing the connector terminal according to the embodiment of the present invention.

As shown in FIG. 3, connector (10) according to the embodiment of the present invention, is mounted on a circuit substrate (not shown) and fit into the mating connector (not shown) to electrically connect the circuit substrate to a cable or a circuit substrate connected to the mating connector. In this embodiment, representations of directions such as “up”, “down”, “left”, “right”, “front”, “rear”, and the like, used for explaining a structure and movement of each part of the connector 10, are not absolute, but relative. These representations are appropriate when the connecter 10 is in the position shown in FIG. 3. If the position of the connector 10 changes, however, it is assumed that these representations are to be changed according to the change of the position of the connector 10.

The connector 10 is formed from an insulating material, and includes a housing 11 and a plurality of conducting terminals 20, mounted so as to pass through terminal through-holes 17 formed in a bottom wall 16 as a terminal holder plate in the housing 11. In the shown example, terminals 20, twenty in total, are disposed in 2 rows with 1.0-mm pitches. However, the number of the terminals 20, the pitch, and the number of the rows may be arbitrarily changed. For example, the terminals 20 may be disposed in one row or more than 2 rows. Additionally, not all terminal through-holes 17 need to have the terminals 20. Some terminals 20 may be omitted as necessary so as to correspond to the arrangement of the mating connecter.

The housing 11 is almost a rectangular parallelepiped box in shape. The housing 11 includes side walls and a bottom wall 16 that define an interior that opens as shown in FIG. 3. A side of the housing 11 which fits into the mating connecter, that is, an end surface of the fitting side, is open, and serves as a fitting opening 12 into which the mating connector (not shown) fits. Further, the engagement bulge 14, as a lock member for locking the mating connector by engaging with an engagement arm portion of the mating connector, is formed as a unit near the upper end of a side of the housing 11. Further, an engagement opening portion 14a for engaging with an engaging projection of the engagement arm portion is formed on the engagement bulge 14. A sidewall 13 opposing to the engagement bulge 14 has an almost flat surface. The connector 10 is a so-called “straight-type” or vertical mount connector, and is mounted on a circuit substrate (not shown) in a standing condition, in other words, in the state where an opening is facing upward.

In this embodiment, the terminals 20 are formed in a shape shown in FIG. 3 to 5 by applying a process, such as stamping, to an electrically conductive metal plate. The terminal 20 includes a connection portion 21, which extends in a direction from the bottom wall 16 of the housing 11 to the fitting opening 12 (upward in FIG. 3) so as to be electrically connected to the mating connector by contacting the terminal of the mating connector; an insertion or mounting portion 22, which is the root or base of the connection portion 21 and inserted into a terminal through-hole 17 formed in the bottom wall 16; a body potion 23, which extends in parallel with the bottom wall 16 in the outer side of the bottom wall 16 (downward in FIG. 3) so as to be connected to the lower end of the insertion portion 22; a tail portion 24, which is connected to an end part of the body portion 23 close to the outer side of the housing 11 and connected to a contact pad of a circuit substrate (not shown) by soldering and the like, including a fixing projection 25. An auxiliary projection is inserted into a fixing concave portion 18 as an auxiliary concave portion formed in the outside surface of the bottom wall 16 (the underside in FIG. 3). The auxiliary projection is connected to the end part of the body portion 23 close to the outer side of the housing 11, extending in the direction of the bottom wall 16, in other words, in the insertion direction of the insertion portion 22. Additionally, on both sides of the insertion portion 22, there are formed a barb or an barb 26 projecting outwards and an inward reentrant anchor concave portion 27 adjoining the upper portion of the barb or barb 26, that is, the front portion of the insertion direction. Additionally, an engagement convex portion 25a projecting outward is formed on both sides of the fixing projection 25.

The terminal 20 is mounted on the housing 11 by a manner in which the terminal 20 is moved relatively to the housing 11 from below the bottom wall 16, the insertion portion 22 is inserted into the terminal through-hole 17 of the bottom wall 16, and the fixing projection 25 is inserted into the fixing concave portion 18. In a state where mounting is completed, as shown in FIG. 3, an upper end of the bottom portion 23 abuts the bottom surface of the bottom wall 16, and the connection portion 21 passes through the terminal through-hole 17 and projects into the housing 11. Further, the engagement convex portion 25a of the fixing projection 25 engages with the sidewall of the fixing concave portion 18 so as to dig into the sidewall thereof. Thereby, the fixing projection 25 is firmly caught by the fixing concave portion 18 so as to prevent the fixing projection 25 from detaching from the fixing concave portion 18.

Additionally, the barb 26 of the fixing projection 22 engages with the sidewall of the terminal through-hole 17 and if the barb digs into the sidewall thereof. At the same time, a portion of the sidewall pushed aside by the barb 26 is displaced the barb or anchor concave portion 27 so as to engage with the anchor concave portion 27. Thereby, the insertion portion 22 is firmly fixed to the terminal through-hole 17 and thus displacement of the insertion portion 22 relative to the terminal through-hole 17 may be prevented, and the detachment of the insertion portion 22 from the terminal through-hole 17 may also be prevented. Therefore, when the connector 10 fits into the mating connector, the terminal 20 will not be displaced even if the connection portion 21 of the terminal 20 is subjected to outer force caused by abutting the terminal, and the like, of the mating connector.

The lower end of the tail portion 24 is connected to the contact pad of the circuit substrate by soldering and the like, and serves as a substrate connection portion electrically connecting to an electrically conductive trace formed on the circuit substrate. Furthermore, the connector 10 is fixed in the circuit substrate by the lower end of the tail portion 24 being connected to the contact pad.

Next, an engagement state between the insertion portion 22 of the terminal 20 and the sidewall of the terminal through-hole 17 is explained in detail.

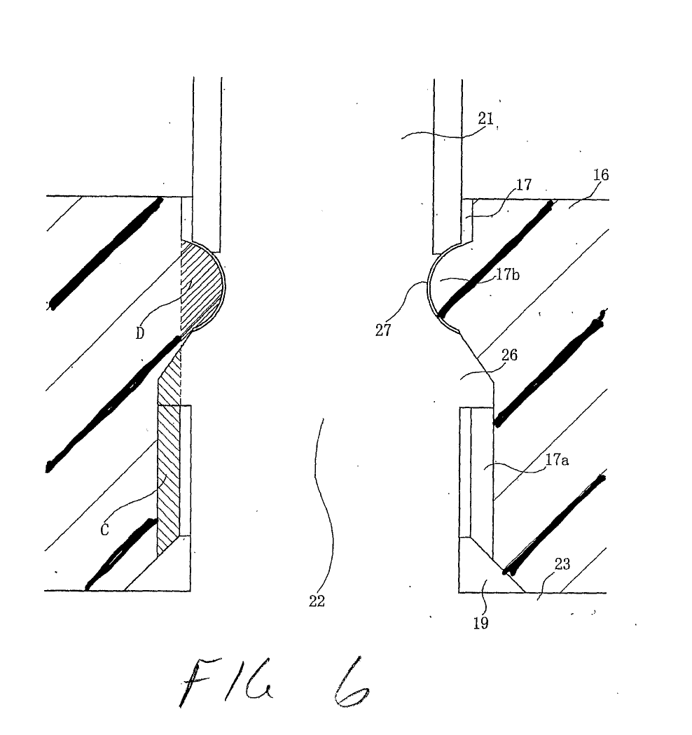

FIG. 6 shows an engagement state between the insertion portion of the terminal and the sidewall of the terminal through-hole according to the embodiment of the present invention, and an enlarged view of B part of FIG. 3.

In this embodiment, as shown in FIG. 6, while the width of the terminal through-hole 17 formed in the bottom wall 16 is formed slightly larger than the width of the insertion portion 22 of the terminal 20, the relationship between the width of the terminal through-hole 17 and the width of the insertion portion 22 may be changed as necessary. Further, while the width of the connection portion 21 of the terminal 20 is formed almost the same as the width of the insertion portion 22, the relationship between the width of the connection portion 21 and the width of the insertion portion 22 may be changed as necessary. Moreover, a taper portion 19 is formed in the bottom edge portion of the bottom wall 16 in the terminal through-hole 17 so as to facilitate insertion of the connection portion 21 and the insertion portion 22 of the terminal 20. However, the taper portion 19 may be omitted as necessary.

As described above, since the bottom wall 16 is made of insulating material, which is softer than the conductor terminal 20, when the insertion portion 22 inserts upwards into the terminal through-hole 17, the barb 26 projecting outwards from the both sides of the insertion portion 22 causes plastic deformation of the insulating material, or the sidewall of the terminal through-hole 17. In this case, since the barb 26 moves upward while digging into the sidewall of the terminal through-hole 17, the portion of the sidewall situated above the barb 26 is pushed aside by the barb 26 and moved upward. Therefore, a hollow portion 17a is formed after the barb 26 has passed through a part of the sidewall, in other words, formed below the barb 26, by the barb 26 pushing aside the sidewall. The hollow portion 17a almost corresponds to the passing trail made by the barb 26 moving upward while digging into the sidewall of the terminal through-hole 17.

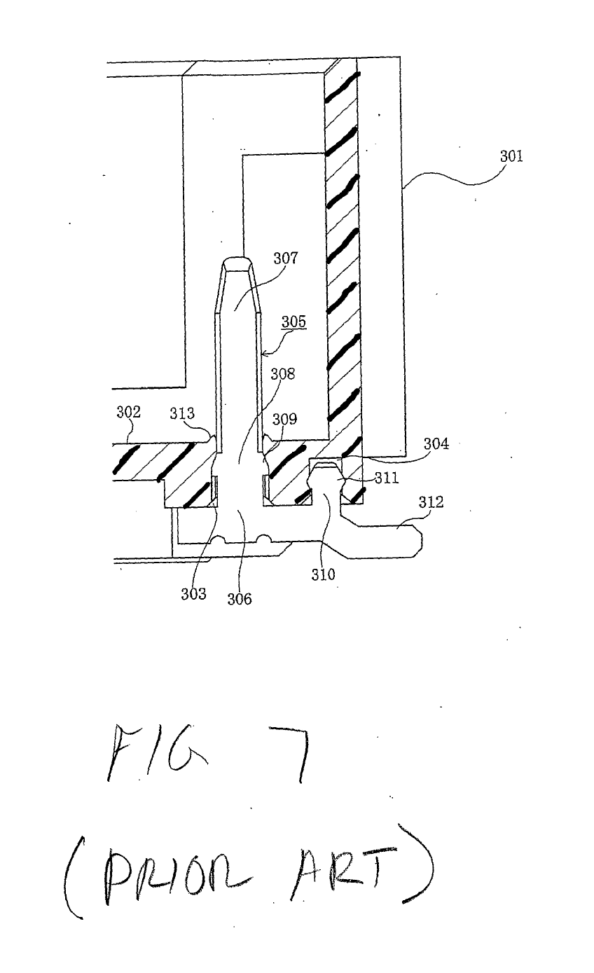

On the other hand, the portion of the sidewall which is pushed aside is gathered in the front part of the barb 26 along the moving direction, that is, a portion above the barb 26. In this state, since the inward reentrant anchor concave portion 27 is formed in a place which is adjacent to the upper part of the barb 26, the gathered portion of the deformed sidewall enters the reentrant portion or anchor concave portion 27, thereby forming the bulge 17b where a part of the sidewall is protruding. Therefore, the gathered portion of the sidewall is moved upwards, thereby preventing a formation of the rise 313 as shown in FIG. 7, which has been described in the Description of the Related Art section. Moreover, as described above, since the bulge 17b enters the reentrant portion 27 and engages with the reentrant portion 27, the effect of firmly fixing the insertion portion 22 into the terminal through-hole 17, that is the anchor effect or retention, increases.

As shown in FIG. 6, the barb 26 and the reentrant portion 27 adjacent to the upper part of the barb 26 are formed in a position where the reentrant portion 27 is not exposed from the front surface of the insertion direction of the bottom wall 16, that is, a position where the reentrant portion 27 is below the upper surface of the bottom wall 16, in a state where the terminal 20 is completely mounted or embedded into the housing 11, that is, in a state where the upper end of the body part 23 abuts the lower surface of the bottom wall 16. Therefore, in a situation where the terminal 20 is completely mounted into the housing 11, airspace is not formed around the terminal 20 on the upper surface of the bottom wall 16. Therefore, there is little possibility that foreign substance enters into a space between the bottom wall 16 and the terminal 20, and also the appearance is not disfigured. Moreover, since the bulge 17b is large enough in size to fully engage with the reentrant portion 27, a sufficient anchor effect may be achieved.

Additionally, the reentrant portion 27 is formed large enough to accommodate the portion of the sidewall pushed aside by the barb 26. In this situation, the amount of the portion of the sidewall pushed aside by the barb 26 is to be a value obtained by multiplying the amount of the sidewall of the terminal through-hole 17 into which the barb 26 digs by the amount of movement of the barb 26 inside the terminal through-hole 17. That is, an area C shown in FIG. 6 is equivalent to the amount of the portion of the sidewall pushed aside by the barb 26. The area C designates a volume of the portion pushed aside from the sidewall of the terminal through-hole 17 by the barb 26 entering the terminal through-hole 17. The area C is equivalent to an amount of area including the hollow portion 17a formed below the barb 26 by pushing away the portion of the sidewall, and one part of the barb 26.

On the other hand, the portion of the sidewall protruding in a position adjoining an upper side of the barb 26 is equivalent to an area D shown in FIG. 6. The amount of the protruding sidewall is equivalent to the amount of the portion of the sidewall pushed aside by the barb 26, and thus the size of the area D is equivalent to the size of the area C. The area D designates the volume of the portion protruding from the sidewall of the terminal through-hole 17 due to the entering of the barb 26 into the terminal through-hole 17. The area D is equivalent to the bulge 17b, and also includes the reentrant portion 27.

In this embodiment, the terminal 20 includes an insertion portion 22 inserted into the terminal through-hole 17 formed on a bottom wall 16 of a housing 11, and a connection portion 21 connected to a front end of insertion direction of the insertion portion 22 and contacting a terminal of the mating connector, the insertion portion 22 includes an barb 26 projecting outwards from both sides of the terminal 20 and digging or skiving into a sidewall of the terminal through-hole 17, and an inward reentrant anchor concave portion 27 formed in a position adjoining a front part of insertion direction of the barb 26, and the reentrant portion 27 is not exposed from a front surface of the bottom wall 16.

Therefore, a periphery of the terminal through-hole 17 situated on an upper side of bottom wall 16 of the housing 11 may be maintained flat, and also insertion force between the insertion portion 22 of the terminal and the terminal through-hole 17 increases due to an anchor effect of the barb 26 and the reentrant portion 27, by which the terminal 20 will not detach from the housing 11. Furthermore, since a rise is not formed on the upper surface of the bottom wall 16 around the terminal 20, the appearance may be kept good as well. Moreover, since airspace is not formed on the upper surface of the bottom wall 16 around the terminal 20, there is little possibility that foreign substance enters into a space between the bottom wall 16 and the terminal 20, and also the appearance is kept good.

Further, the sidewall of the terminal through-hole 17 includes a hollow portion 17a formed on a back side of the insertion direction of the barb 26 by being pushed aside by the barb 26, and a bulge 17b formed on the front side of the insertion direction of the barb 26 and entering the anchor concave portion 27. Additionally, a volume of the bulge 17b is equivalent to a volume of the portion pushed aside by the barb 26.

Therefore, the bulge 17b is large enough in size to fully engage with the anchor concave portion 27, and therefore sufficient anchor effect may be achieved.

Further, the bottom wall 16 includes a fixing concave portion 18 formed on a surface on the back side of the insertion direction, the terminal 20 includes a body portion 23 connected at the back end of the insertion direction of the insertion portion 22, and a fixing projection 25 extending from the body portion 23 along the insertion direction, and the fixing projection 25 is inserted into the fixing concave portion 18 so as to be caught thereby. The terminal 20 is firmly fixed on the bottom wall 16, and therefore when the connector 10 fits into the mating connector, the terminal 20 will not detach from the bottom wall 16 or be displaced even if the connection portion 21 of the terminal 20 is subjected to outer force caused by abutting a terminal, and the like, of the mating connector.

Note that the fixing projection 25 and the fixing concave portion 18 may be omitted if unnecessary.

It should be noted here that the present invention is not limited to the above embodiment, but can be variously modified and changed within the gist of the invention. Thus the modifications and changes are not excluded from the scope of the present invention.

What is claimed is:

1. A connector comprising:
an insulative housing, the housing including a plurality of terminal-receiving cavities for receiving terminals inserted therein in a terminal insertion direction;
a plurality of conductive terminals, each said terminal being mounted in one of the terminal-receiving cavities, each of the conductive terminals including a contacting portion, a terminating portion and a retention portion, the retention portion including at least one barb member projecting therefrom and at least one reentrant portion extending thereinto, the reentrant portion being positioned adjacent the barb member and in front of said barb member along the terminal insertion direction and wherein material displaced by said barb member is received in the reentrant portion upon insertion of the terminal in the terminal-receiving cavity of said housing.

2. The connector of claim 1 wherein each of said conductive terminals includes an auxiliary retention portion laterally offset from the said retention portion relative to the terminal insertion direction.

3. The connector of claim 1 wherein said housing includes a plurality of side walls and a bottom wall cooperatively defining an opening for receiving a mating connector.

4. The connector of claim 3 wherein the terminal-receiving cavities are formed in the bottom wall of said housing.

5. The connector of claim 4 wherein said reentrant portion of each said terminal is within one of the terminal-receiving cavities.

6. A connector comprising:
an insulative housing having a plurality of terminal-receiving cavities;
a plurality of conductive terminals inserted into the terminal-receiving cavities in a terminal insertion direction, each of the conductive terminals including a contacting portion, a terminating portion, and a retention portion, the retention portion including at least one barb member projecting from the retention portion and at least one reentrant portion extending into the retention portion, the reentrant portion being positioned adjacent the barb member and in front of the barb member in the insertion direction, said retention portion further including an auxiliary retention portion laterally offset from said retention portion, the auxiliary retention portion including a projection that is inserted into a recess formed in said insulative housing; and
wherein material displaced by said barb member is received in said reentrant portion during insertion of said terminal in said terminal-receiving cavity of said housing.

7. The connector of claim 6 wherein said housing includes a plurality of side walls and a bottom wall cooperatively defining an opening for receiving a mating connector.

8. The connector of claim 7 wherein the terminal-receiving cavities are formed in the bottom wall of said housing.

9. The connector of claim 8 wherein said reentrant portion of each said conductive terminal is embedded in one of said terminal-receiving cavities.

10. A connector comprising:
an insulative housing having side surfaces and a bottom surface interconnecting the side surfaces, the side surfaces and bottom surface defining an opening for receiving a mating connector, the bottom surface including a plurality of terminal-receiving passageways extending therethrough,
a plurality of conductive terminals inserted in the terminal-receiving passageways in a terminal insertion direction, each of the conductive terminals including a contacting portion, a terminating portion and a retention portion, the retention portion including at least one barb member projecting therefrom and at least one reentrant portion extending thereinto, the reentrant portion being located adjacent the barb member and in front of said barb member relative to the insertion direction; and
wherein material displaced by said barb member during insertion into said terminal-receiving cavity is received in said reentrant portion.

11. The connector of claim 10 wherein each of said conductive terminals includes an auxiliary retention portion laterally offset from said retention portion and along said insertion direction.

12. The connector of claim 10 wherein each said reentrant portion of said retention portion is completely within one of said terminal receiving cavities within said bottom wall of said housing.
